(19) United States
(12) Patent Application Publication
(10) Pub. No.: US 2025/0312866 A1
(43) Pub. Date: Oct. 9, 2025

(54) NOZZLE DESIGN FOR LASER WATERJET MICRO-MACHINING

(71) Applicant: SILFEX, INC., Eaton, OH (US)

(72) Inventors: Rong WANG, Springboro, OH (US); Chawa MSACHI, Liberty Twp., OH (US); Douglas J. JEFFERIES, Connersville, IN (US); Ronnie GILLESPIE, Connersville, IN (US)

(21) Appl. No.: 18/865,126

(22) PCT Filed: May 10, 2023
(86) PCT No.: PCT/US2023/021631

§ 371 Date: Nov. 12, 2024

Related U.S. Application Data
(60) Provisional application No. 63/344,848, filed on May 23, 2022.

(51) Int. Cl. B23K 26/14

(52) U.S. Cl. CPC B23K 26/1462

(57) ABSTRACT

A waterjet nozzle assembly for a waterjet guided laser machining system includes a housing, a nozzle arranged within the housing, and a nozzle nut configured to retain the nozzle within the housing. The nozzle is configured to receive and inject a laser and a stream of water through a channel defined within the nozzle and the nozzle nut and out of an outlet of the waterjet nozzle assembly. A gas channel in fluid communication with the channel is defined within the waterjet nozzle assembly. A plate is arranged between the nozzle and the nozzle nut and is configured to separate the channel into a first portion within the nozzle and a second portion within the nozzle nut, allow gas to flow from the gas channel, through the plate, and into the nozzle, and prevent gas flow from the second portion of the channel into the first portion of the channel.

### CROSS-REFERENCE TO RELATED APPLICATIONS

This application claims the benefit of U.S. Provisional Application No. 63/344,848, filed on May 23, 2022. The entire disclosure of the above application is incorporated herein by reference.

### FIELD

The present disclosure relates to waterjet guided laser machining systems, and more particularly to laser waterjet nozzles for waterjet guided laser machining systems.

### BACKGROUND

The background description provided here is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

Liquid (e.g., waterjet) guided laser machining systems include a waterjet nozzle configured to direct a jet or stream of water at a surface of a workpiece.

### SUMMARY

A waterjet nozzle assembly for a waterjet guided laser machining system includes a housing, a nozzle arranged within the housing, and a nozzle nut configured to retain the nozzle within the housing. The nozzle is configured to receive and inject a laser and a stream of water through a channel defined within the nozzle and the nozzle nut and out of an outlet of the waterjet nozzle assembly. A gas channel is defined within the waterjet nozzle assembly and is in fluid communication with the channel. A plate is arranged between the nozzle and the nozzle nut and is configured to separate the channel into a first portion within the nozzle and a second portion within the nozzle nut, allow gas to flow from the gas channel, through the plate, and into the nozzle, and prevent gas flow from the second portion of the channel within the nozzle nut into the first portion of the channel within the nozzle.

In other features, the plate includes a central opening aligned with the laser and the stream of water and at least one outer opening radially outside of the central opening. The at least one outer opening is located directly above the gas channel. An upper surface of the plate defines a plenum between the upper surface and a lower surface of the nozzle, and wherein the plate is configured to allow gas to flow from the gas channel into the plenum through the at least one opening and from the plenum into the first portion of the channel within the nozzle. The plate includes an annular rim extending upward from an outer perimeter of the upper surface and the plenum is defined between the annular rim, the upper surface of the plate, and the lower surface of the nozzle.

In other features, the plate includes at least one clocking tab extending downward from an outer perimeter of a lower surface of the plate and the at least one clocking tab is configured to align the at least one opening with the gas channel. A lower end of the nozzle includes a recess configured to retain the plate. An upper end of the nozzle nut includes a recess configured to retain the plate. The plate is comprised of at least one of brass and copper. The waterjet nozzle further includes a diaphragm arranged below the nozzle nut and above the outlet of the waterjet nozzle assembly. The diaphragm includes a center hole aligned with the laser and the stream of water. The diaphragm includes at least one side opening located radially outside of the center hole. The at least one side opening is configured to allow water to flow out of the waterjet nozzle assembly and through the outlet.

Further areas of applicability of the present disclosure will become apparent from the detailed description, the claims and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1A is an example waterjet nozzle assembly for a water guided laser machining system;

FIG. 1B is a plan view of an example diaphragm of the waterjet nozzle assembly of FIG. 1A;

FIG. 2A is an example waterjet nozzle assembly including a plate arranged below a nozzle; and

FIGS. 2B and 2C are top and bottom views, respectively, of the plate of FIG. 2A.

In the drawings, reference numbers may be reused to identify similar and/or identical elements.

### DETAILED DESCRIPTION

A waterjet nozzle is configured inject a laser into a stream of water to cut and/or remove material from a surface of a workpiece, such as a component of a substrate processing system. The water guides the laser, removes debris, and cools the surface of the workpiece. For example, the stream of water is directed through a center opening or hole at a bottom end of a nozzle assembly and the laser is injected into the stream of water through the center opening.

During operation, debris (e.g., dust comprised of the removed material, such as silicon dust removed from a silicon component of a substrate processing system) from the workpiece enters the nozzle assembly and is deposited on the nozzle and other surfaces within the nozzle assembly. The debris interferes with nozzle operation and reduces nozzle lifetime.

A waterjet nozzle assembly according to the present disclosure includes a plate arranged within the nozzle assembly adjacent to the nozzle. For example, the plate is arranged between the nozzle and a nozzle nut. The plate is configured to allow a protective gas (e.g., helium) to flow above the plate inside the nozzle to prevent debris from entering the nozzle. Accordingly, any debris that enters the nozzle assembly is restricted to a lower portion of the nozzle assembly below the nozzle and the plate.

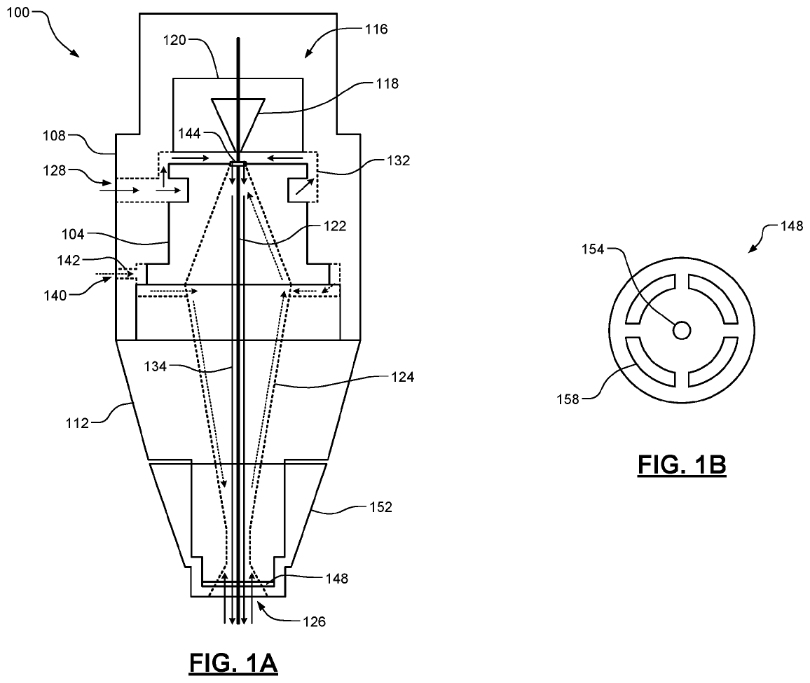

FIG. 1A shows an example waterjet nozzle assembly 100 according to the present disclosure. The nozzle assembly 100 encloses a nozzle 104 within a housing 108. For example, the nozzle 104 is comprised of brass. In some examples, the nozzle assembly 100 includes a nozzle nut 112 configured to retain the nozzle 104 within the housing 108.

A laser focus assembly 116 focuses (as shown at 118) a laser using a window (e.g., a quartz window) 120 arranged above the nozzle 104. The laser 122 is directed downward into a cavity or channel 124 defined within nozzle 104 and the housing 108 (e.g., within the nozzle nut 112) and out of the nozzle assembly 100 through an outlet 126. Liquid, such as water, is injected into the nozzle assembly 100 via a water inlet 128 and into a water channel 132 defined within the housing 108 and around the nozzle 104. The water forms a stream 134 that is injected into the nozzle 104 and downward through the channel 124. The stream 134 guides and maintains an alignment of the laser 122. Flow of the water within the nozzle assembly 100 is generally represented by solid arrows.

In some examples, a gas, such as helium, is injected into the nozzle assembly 100 via a gas inlet 140 and into a gas channel 142 defined within the housing 108 and the nozzle nut 112 and into the channel 124 below the nozzle 104. The gas flows downward within the channel 124 to maintain a desired flow pattern of the stream 134 (e.g., a laminar flow pattern). The channel 124 defined within the nozzle nut 112 is configured to maintain and stabilize the flow pattern of the stream 134 and the gas. Flow of the gas within the nozzle assembly 100 is generally represented by dashed arrows.

While the gas flows generally downward, the gas may flow back upward from the outlet 126 to the nozzle 104. Water and/or debris (e.g., silicon dust) may reenter the nozzle assembly 100 through the outlet 126. For example, backsplash from the workpiece may be projected upward. The upward gas flow within the channel 124 may carry water and debris into the nozzle 104. Debris may be deposited on and/or damage surfaces of the nozzle 104, an optical head (e.g., a sapphire or diamond optical head) 144 arranged in an opening between the laser focus assembly 116 and the nozzle 104, the window 120, etc.

Accordingly, in some examples, a plate or diaphragm (e.g., a brass diaphragm) 148 is arranged in the channel 124 above the outlet 126 to prevent water and debris from reentering the nozzle assembly 100. For example, a diaphragm nut 152 retains a position of the diaphragm 148 against the nozzle nut 112. As shown in plan view in FIG. 1B, the diaphragm 148 includes a center hole 154. The laser 122 and the stream 134 of water pass through the center hole 154. The diaphragm 148 includes one or more side openings 158. The side openings 158 allow excess water within the nozzle assembly 100 to drain out of the channel 124, through diaphragm 148, and out the outlet 126. However, the side openings 158 allow water and debris to reenter the channel 124 through the outlet 126.

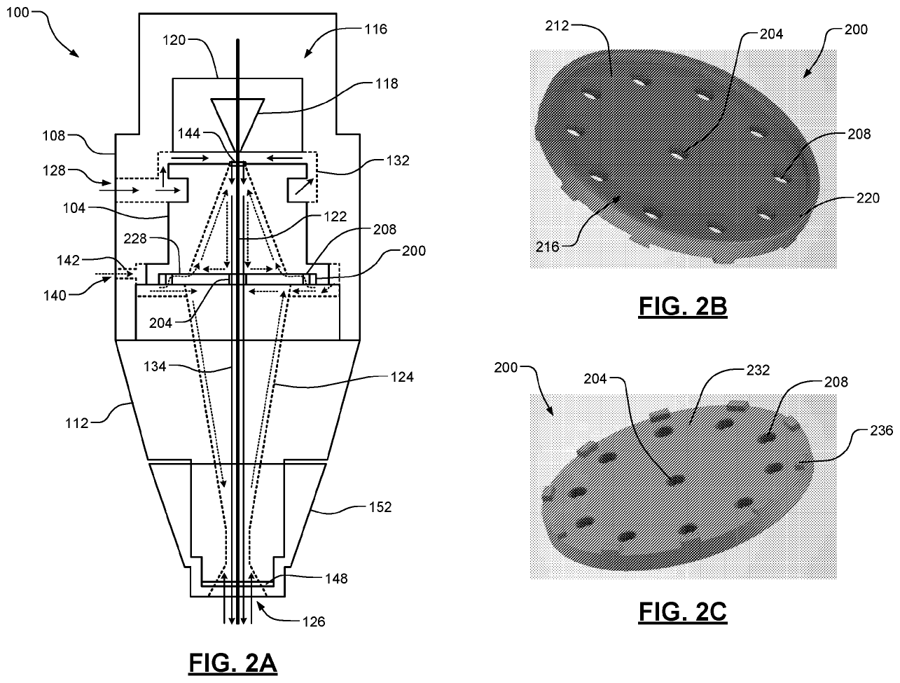

Referring now to FIGS. 2A, 2B, and 2C, another example of the nozzle assembly 100 according to the present disclosure includes a plate (e.g., a plate comprised of brass, copper, etc.) 200 arranged below and adjacent to the nozzle 104. The plate 200 may be provided instead of or in addition to the diaphragm 148. For example, the plate 200 is arranged in the channel 124 between the nozzle 104 and the nozzle nut 112. The plate 200 divides and separates the channel 124 into an upper portion defined within the nozzle 104 and a lower portion defined within the nozzle nut 112 and the diaphragm nut 152. The plate 200 is configured to allow the gas to flow above the plate 200 inside the nozzle 104 to prevent debris from entering the nozzle 104 and coming into contact with surfaces of the nozzle 104, the window 120, the optical head 144, etc. Accordingly, any debris that enters the nozzle assembly 100 through the outlet 126 and the diaphragm 148 is restricted to a lower portion of the nozzle assembly 100 below the plate 200.

For example, the plate 200 includes a central opening 204 that allows the laser 122 and the stream 134 to pass through the plate 200 and exit the nozzle 104. The plate 200 further includes outer gas holes or openings 208. The openings 208 are positioned to allow protective gas (i.e., the helium injected into the gas channel 142) to flow upward from the gas channel 142 through the plate 200 and into the channel 124 within the nozzle 104. For example, the openings 208 are aligned with respective outlets of the gas channel 142. The gas flows upward along an outer edge of the channel 124 and then downward along the stream 134 toward the central opening 204. In this manner, the plate 200 prevents debris from entering the nozzle 104 and the gas flow pattern within the nozzle 104 prevents debris from entering the nozzle 104 through the central opening 204.

As shown, the openings 208 are located radially outside of the channel 124 within the nozzle nut 112. In other words, the openings 208 are located directly above and are aligned with the gas channel 142 but are not directly above the channel 124 through the nozzle nut 112. Accordingly, the openings 208 are located outside of the gas flow pattern of the gas within the nozzle nut 112. As such, water and debris within the nozzle nut 112 carried by the gas are not brought into proximity with the openings 208 and are prevented from entering the openings 208.

Top and bottom views of the plate 200 are shown in more detail in FIGS. 2B and 2C, respectively. Although shown as a single piece, in some examples the plate 200 may be comprised of separate components. As shown in FIG. 2B, an upper surface 212 of the plate 200 includes a recess or plenum 216. For example, the plate 200 includes an annular rim 220 extending upward from an outer perimeter the upper surface 212 to define the plenum 216. The plenum 216 is further defined between the upper surface 212 of the plate 200 and a lower surface of the nozzle 104. In this manner, gas flowing upward through the openings 208 enters and fills the plenum 216 and flows from the plenum 216 into an interior of the nozzle 104. Although shown as generally circular holes, in other examples the openings 208 may be implemented as slots or other types of openings.

As shown in FIG. 2A, a lower end of the nozzle 104 includes a recess or cutout 228 configured to receive and retain the plate 200. In other examples, the plate 200 may instead be arranged within the nozzle nut 112 (e.g., in a cutout defined in an upper end of the nozzle nut 112), partially in each of the nozzle 104 and the nozzle nut 112, etc.

As shown in FIG. 2C, a lower surface 232 of the plate 200 includes one or more clocking tabs 236 extending downward from an outer perimeter of the lower surface 232. The clocking tabs 236 facilitate alignment of the plate 200 and the openings 208 with the gas channel 142. For example, the clocking tabs 236 are configured to align the openings with the respective outlets of the gas channel 142.

As described above, debris entering the nozzle assembly 100 is restricted to only a lower portion of the channel 124 within the nozzle not 112 and is prevented from entering an upper portion of the channel 124 within the nozzle 104. Accordingly, the plate 200 protects the interior of the nozzle 104, the window 120, the optical head 144, etc. from buildup and damage caused by water and debris reentering the nozzle assembly through the outlet 126 and the diaphragm 148.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In some implementations, a controller is part of a system, which may be part of the above-described examples. Such systems can comprise semiconductor processing equipment, including a processing tool or tools, chamber or chambers, a platform or platforms for processing, and/or specific processing components (a wafer pedestal, a gas flow system, etc.). These systems may be integrated with electronics for controlling their operation before, during, and after processing of a semiconductor wafer or substrate. The electronics may be referred to as the “controller,” which may control various components or subparts of the system or systems. The controller, depending on the processing requirements and/or the type of system, may be programmed to control any of the processes disclosed herein, including the delivery of processing gases, temperature settings (e.g., heating and/or cooling), pressure settings, vacuum settings, power settings, radio frequency (RF) generator settings, RF matching circuit settings, frequency settings, flow rate settings, fluid delivery settings, positional and operation settings, wafer transfers into and out of a tool and other transfer tools and/or load locks connected to or interfaced with a specific system.

Broadly speaking, the controller may be defined as electronics having various integrated circuits, logic, memory, and/or software that receive instructions, issue instructions, control operation, enable cleaning operations, enable endpoint measurements, and the like. The integrated circuits may include chips in the form of firmware that store program instructions, digital signal processors (DSPs), chips defined as application specific integrated circuits (ASICs), and/or one or more microprocessors, or microcontrollers that execute program instructions (e.g., software). Program instructions may be instructions communicated to the controller in the form of various individual settings (or program files), defining operational parameters for carrying out a particular process on or for a semiconductor wafer or to a system. The operational parameters may, in some embodiments, be part of a recipe defined by process engineers to accomplish one or more processing steps during the fabrication of one or more layers, materials, metals, oxides, silicon, silicon dioxide, surfaces, circuits, and/or dies of a wafer.

The controller, in some implementations, may be a part of or coupled to a computer that is integrated with the system, coupled to the system, otherwise networked to the system, or a combination thereof. For example, the controller may be in the “cloud” or all or a part of a fab host computer system, which can allow for remote access of the wafer processing. The computer may enable remote access to the system to monitor current progress of fabrication operations, examine a history of past fabrication operations, examine trends or performance metrics from a plurality of fabrication operations, to change parameters of current processing, to set processing steps to follow a current processing, or to start a new process. In some examples, a remote computer (e.g., a server) can provide process recipes to a system over a network, which may include a local network or the Internet. The remote computer may include a user interface that enables entry or programming of parameters and/or settings, which are then communicated to the system from the remote computer. In some examples, the controller receives instructions in the form of data, which specify parameters for each of the processing steps to be performed during one or more operations. It should be understood that the parameters may be specific to the type of process to be performed and the type of tool that the controller is configured to interface with or control. Thus as described above, the controller may be distributed, such as by comprising one or more discrete controllers that are networked together and working towards a common purpose, such as the processes and controls described herein. An example of a distributed controller for such purposes would be one or more integrated circuits on a chamber in communication with one or more integrated circuits located remotely (such as at the platform level or as part of a remote computer) that combine to control a process on the chamber.

Without limitation, example systems may include a plasma etch chamber or module, a deposition chamber or module, a spin-rinse chamber or module, a metal plating chamber or module, a clean chamber or module, a bevel edge etch chamber or module, a physical vapor deposition (PVD) chamber or module, a chemical vapor deposition (CVD) chamber or module, an atomic layer deposition (ALD) chamber or module, an atomic layer etch (ALE) chamber or module, an ion implantation chamber or module, a track chamber or module, and any other semiconductor processing systems that may be associated or used in the fabrication and/or manufacturing of semiconductor wafers.

As noted above, depending on the process step or steps to be performed by the tool, the controller might communicate with one or more of other tool circuits or modules, other tool components, cluster tools, other tool interfaces, adjacent tools, neighboring tools, tools located throughout a factory, a main computer, another controller, or tools used in material transport that bring containers of wafers to and from tool locations and/or load ports in a semiconductor manufacturing factory.

What is claimed is:

1. A waterjet nozzle assembly for a waterjet guided laser machining system, the waterjet nozzle assembly comprising:
a housing;
a nozzle arranged within the housing;
a nozzle nut configured to retain the nozzle within the housing,
wherein the nozzle is configured to receive and inject a laser beam and a stream of water through a first channel defined within the nozzle and the nozzle nut and out of an outlet of the waterjet nozzle assembly, and
wherein the nozzle nut guides the laser beam and the stream of water;
a gas channel defined within the waterjet nozzle assembly, the gas channel in fluid communication with the first channel; and
a plate arranged between the nozzle and the nozzle nut, the plate configured to (i) separate the first channel into a first portion within the nozzle and a second portion within the nozzle nut, (ii) allow gas to flow from the gas channel, through the plate, and into the nozzle, and (iii) prevent gas flow from the second portion of the first channel within the nozzle nut into the first portion of the first channel within the nozzle.

2. The waterjet nozzle assembly of claim 1, wherein the plate includes (i) a central opening aligned with the laser beam and the stream of water and (ii) at least one outer opening radially outside of the central opening.

3. The waterjet nozzle assembly of claim 2, wherein the at least one outer opening is located directly above the gas channel.

4. The waterjet nozzle assembly of claim 3, wherein an upper surface of the plate defines a plenum between the upper surface and a lower surface of the nozzle, and wherein the plate is configured to allow gas to flow from the gas channel into the plenum through the at least one opening and from the plenum into the first portion of the first channel within the nozzle.

5. The waterjet nozzle assembly of claim 4, wherein the plate includes an annular rim extending upward from an outer perimeter of the upper surface, and wherein the plenum is defined between the annular rim, the upper surface of the plate, and the lower surface of the nozzle.

6. The waterjet nozzle assembly of claim 1, wherein the plate includes at least one clocking tab extending downward from an outer perimeter of a lower surface of the plate, and wherein the at least one clocking tab is configured to align the at least one opening with the gas channel.

7. The waterjet nozzle assembly of claim 1, wherein a lower end of the nozzle includes a recess configured to retain the plate.

8. The waterjet nozzle assembly of claim 1, wherein an upper end of the nozzle nut includes a recess configured to retain the plate.

9. The waterjet nozzle assembly of claim 1, wherein the plate is comprised of at least one of brass and copper.

10. The waterjet nozzle assembly of claim 1, further comprising a diaphragm arranged below the nozzle nut and above the outlet of the waterjet nozzle assembly, wherein the diaphragm includes a center hole aligned with the laser beam and the stream of water.

11. The waterjet nozzle assembly of claim 10, wherein the diaphragm includes at least one side opening located radially outside of the center hole, wherein the at least one side opening is configured to allow water to flow out of the waterjet nozzle assembly and through the outlet.

12. The waterjet nozzle assembly of claim 1, wherein the nozzle nut guides a portion of the laser beam and the stream of water subsequent to the portion of the laser beam and the stream of water passing through the plate.

13. The waterjet nozzle assembly of claim 1, wherein a central opening of the plate, through which gas flows from within the nozzle to an area outside of the nozzle, is disposed in the nozzle.

14. The waterjet nozzle assembly of claim 1, wherein a central opening of the plate, through which gas flows from within the nozzle to an area outside of the nozzle, is disposed in the nozzle and between the nozzle and the nozzle nut.

15. The waterjet nozzle assembly of claim 1, wherein a central opening of the plate, through which gas flows from within the nozzle to an area outside of the nozzle, is disposed in the nozzle, in the housing, and upstream from the nozzle nut.

16. The waterjet nozzle assembly of claim 1, wherein the nozzle nut comprises an interior surface that directly faces the laser beam and the stream of water.

17. The waterjet nozzle assembly of claim 1, wherein the plate does not extend within the nozzle nut.

18. The waterjet nozzle assembly of claim 1, wherein the plate is completely disposed in the nozzle.
